(19) United States
(12) Patent Application Publication
(10) Pub. No.: US 2018/0060379 A1
(43) Pub. Date: Mar. 1, 2018

(54) AUTOMATED CORRELATION AND DEDUPLICATION OF IDENTITIES

(71) Applicant: CA, Inc., NEW YORK, NY (US)

(72) Inventors: WILLIAM MICHAEL HARROD, FAIRFAX, VA (US); MARK WILLIAM EMEIS, MONUMENT, CO (US)

(21) Appl. No.: 15/254,452

(22) Filed: Sep. 1, 2016

(51) Int. Cl. G06F 17/30

(52) U.S. Cl. CPC G06F 17/30371; G06F 17/30876

(57) ABSTRACT

An automated correlation and deduplication of identities process enables a single identity to be utilized across the enterprise for a user. During a user enrollment process, a requesting system captures user attributes. The requesting system sends a message with a portion of the attributes across a message bus that other identity providers receive. The other identity providers provide a listing of potential matches that are processed by a correlation engine that analyzes variables to predict the likelihood of a potential match being the particular user. If the likelihood reaches a predetermined threshold, the corresponding potential match is correlated to the particular user through a mapped linkage and recorded in an identity repository. If the likelihood does not reach a predetermined threshold, the corresponding potential match is dismissed as not being sufficiently likely that a correlation exists or resubmitted through the process as needing additional clarifying details.

### BACKGROUND

There is an increased volume of user accounts that should be associated with a given person (i.e., user), but are not due to slight variations in the enrollment process or user names. Government and large enterprise clients offer many online services to their users (e.g., citizens, customers). Users typically self-register for access to these services but often forget login credentials (e.g., user identification, identity, password) or in some cases, that they already have an account. As a result, many users simply create new accounts when returning to access the services, thereby establishing a different identity. Different information may be provided each time a new account is created which prevents the new account from being correlated to an existing identity, and ultimately the proper user. Historically, for Internet facing applications, companies and government agencies were not concerned with duplicative account creation and did not architect to be able to address this issue. This has led to multiple identities for a single user which reduces the quality of service for that user, increases the risk of identity and monetary fraud, and increases the complexity and cost in managing the users and identities for providers of the services.

Existing solutions only provide, in a serial fashion, a list of potential matches that must be manually reviewed. However, this process is slow, expensive, and does not automate the actual linkage of the accounts to the identity. Further, these solutions rely on information such as social security numbers. For legal and administrative reasons, as well as the fact that social security numbers have been widely compromised and can be looked up on the Internet, social security numbers are no longer a reliable linking attribute.

### SUMMARY

This summary is provided to introduce a selection of concepts in a simplified form that are further described below in the detailed description. This summary is not intended to identify key features or essential features of the claimed subject matter, nor should it be used as an aid in determining the scope of the claimed subject matter.

Embodiments of the present disclosure relate to providing automated correlation and deduplication of identities. To do so, during the user enrollment process, a requesting system captures user attributes. These user attributes are utilized to determine if a particular user already has an account/identity. The requesting system sends a message with a portion of the identifying attributes across a message bus that other identity providers receive. The other identity providers provide a listing of potential matches that are processed by a correlation engine to predict the likelihood of a potential match being the particular user. The correlation engine analyzes a number of variables about each potential match. If the likelihood reaches a predetermined threshold, the corresponding potential match is correlated to the particular user through a mapped linkage and recorded in an identity repository. If the likelihood does not reach a predetermined threshold, the corresponding potential match is dismissed as not being sufficiently likely that a correlation exists or resubmitted through the process as needing additional clarifying details. In this way, a single identity can be mapped to each user account corresponding to a particular user, or more simply, one identity can be used across the enterprise for one user.

### BRIEF DESCRIPTION OF THE DRAWINGS

The present disclosure is described in detail below with reference to the attached drawing figures, wherein:

FIG. 1 is a block diagram showing an identity correlation system for correlation and deduplication of identities, in accordance with an embodiment of the present disclosure;

FIG. 2 is a flow diagram showing a method for facilitating automated correlation and deduplication of identities, in accordance with an embodiment of the present disclosure;

FIG. 3 is a flow diagram showing a method for facilitating automated correlation and deduplication of identities using additional identity attributes, in accordance with an embodiment of the present disclosure;

FIG. 4 is a flow diagram showing a method for facilitating automated correlation and deduplication of identities, in accordance with an embodiment of the present disclosure; and

FIG. 5 is a block diagram of an exemplary computing environment suitable for use in implementing embodiments of the present disclosure.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

As noted in the background, users typically self-registering for access to online services often forget login credentials (e.g., user identification, account name, identity, password) or in some cases, that they already have an account. Consequently, many users simply create new accounts when returning to access the services, thereby establishing a different identity. Different information may be provided each time a new account is created, which prevents the new account from being correlated to an existing identity, and ultimately establishing a unique identity that does not properly correlate to the actual individual user. This leads to multiple identities for a single user which reduces the quality of service for that user, increases the risk of identity and monetary fraud, and increases the complexity and cost in managing the users and identities for providers of the services.

For example, users enrolling to receive government benefits such as workers' compensation or unemployment insurance often do so through online applications. Users typical register, get an account (e.g., identity and password), and receive benefits for some limited period of time (e.g., several months). Users may not use that account again for some time. When the user needs to apply for and receive benefits again at some point in the future, the user may not remember the user identification, or that the user already has an account. In addition, the user may no longer be able to access the email address associated with the prior user identification so attempts to recover the user identification are not received. In these cases, the user likely begins a new enrollment process, registers, and receives a new account with a different user identification. However, the history and attributes associated with the first user identification are not properly correlated with the new user identification and the government agency and/or the user may be shortchanged (e.g., benefits received/provided) as a result.

In another example, an enterprise organization may have multiple user stores with the same users holding identities across the multiple stores (e.g., due to multiple disconnected applications and user stores, or through mergers and acquisitions). Because there is no existing automated process to identify and correlate the identities across those multiple user stores and de-duplicate the identity mapping to accounts across the enterprise, these identities remain disconnected. As a result, the enterprise organization and/or the user may be shortchanged (e.g., benefits received/provided).

Embodiments of the present disclosure are generally directed to providing automated correlation and deduplication of identities. During the user enrollment process, a requesting system captures user attributes that can be utilized to determine if a particular user already has an account/identity. The requesting system sends a message with a portion of the identifying attributes across a message bus that other identity providers receive. In response, the other identity providers provide a listing of potential matches that are processed by a correlation engine to predict the likelihood of a potential match being the particular user. To do so, the correlation engine analyzes a number of variables about each potential match (e.g., freshness of the data that the potential match is based on, strength of the potential match, number of independent attributes that match, etc.).

If the likelihood reaches a predetermined threshold, the corresponding potential match is correlated to the particular user through a mapped linkage and recorded in an identity repository. If the likelihood does not reach a predetermined threshold, the corresponding potential match is dismissed as not being sufficiently likely that a correlation exists or resubmitted through the process as needing additional clarifying details. In this way, a single identity can be mapped to each user account corresponding to a particular user, or more simply, one identity can be used across the enterprise for one user. The matching correlation threshold may vary based on the risk of identity or monetary fraud or other risk factors.

Accordingly, one embodiment of the present disclosure is directed to a non-transitory computer storage medium storing computer-useable instructions that, when used by a computing device, cause the computing device to perform operations to facilitate automated correlation and deduplication of identities. The operations include receiving identity attributes associated with a new user account from a requesting system. The operations also include communicating a portion of the received identity attributes to an identity provider. The operations further include receiving a potentially matching user account from the identity provider. The potentially matching user account includes local identity attributes and is based on a comparison of the portion of received identity attributes to the local identity attributes. The operations also include analyzing a freshness of the local identity attributes for the received potentially matching user account, a quality of the received potentially matching user account, or a number of identity attributes corresponding to the received potentially matching user account to determine a likely matching user account. The operations further include establishing a mapped linkage between the new user account and the determined likely matching user account for storage in an identity repository.

In another embodiment, the present disclosure is directed to a computer-implemented method to facilitate automated correlation and deduplication of identities. The method comprises receiving identity attributes associated with a new user account from a requesting system. The method also comprises communicating a portion of the received identity attributes to an identity provider. The method further comprises receiving a potentially matching user account from the identity provider. The potentially matching user account comprises local identity attributes and is based on a comparison of the portion of received identity attributes to the local identity attributes. The method also comprises analyzing the potentially matching user account to predict a likelihood of the potentially matching user account being a likely matching user account. The method further comprises, upon the likelihood not meeting a predetermined threshold, requesting additional identity attributes from the user via the requesting system.

In yet another embodiment, the present disclosure is directed to a system for facilitating automated correlation and deduplication of identities. The system includes a processor and a computer storage medium storing computer-useable instructions that, when used by the processor, cause the processor to determine that identity attributes associated with a new user account received from a requesting system correspond to a potentially matching user account. The potentially matching user account is received from an identity provider and is based on a comparison of the identity attributes to local identity attributes associated with an established user account known by the identity provider. The potentially matching user account is analyzed to predict a likelihood of the potentially matching user account being a likely matching user account. Upon the likelihood meeting a predetermined threshold, a mapped linkage is established between the new user account and the likely matching user account for storage in an identity repository. Upon the likelihood not meeting a predetermined threshold, additional identity attributes are requested from the user via the requesting system.

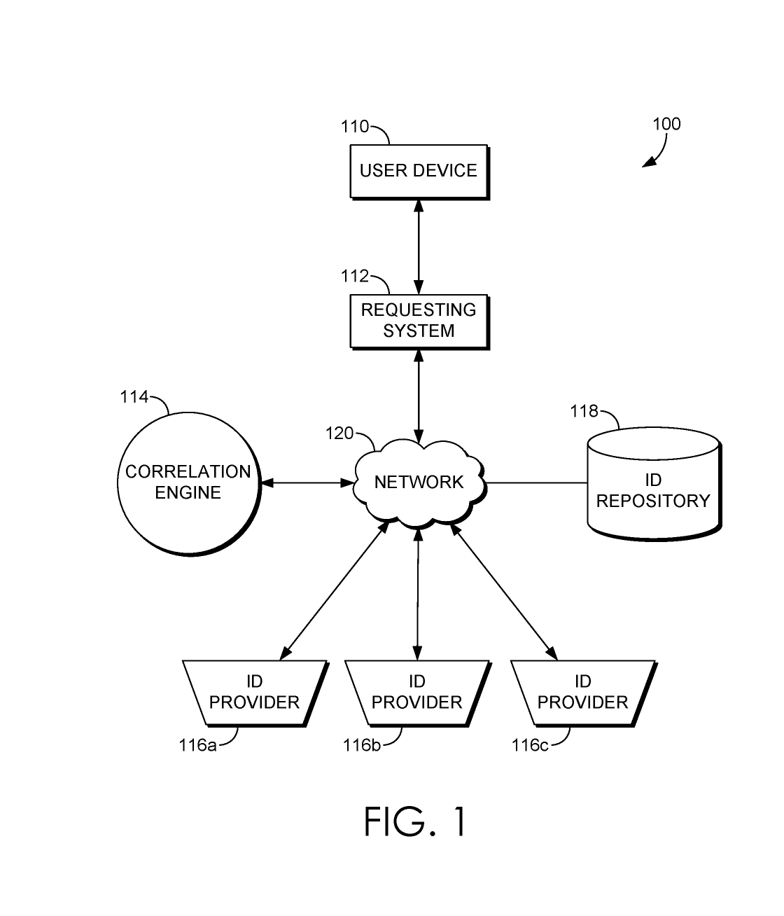

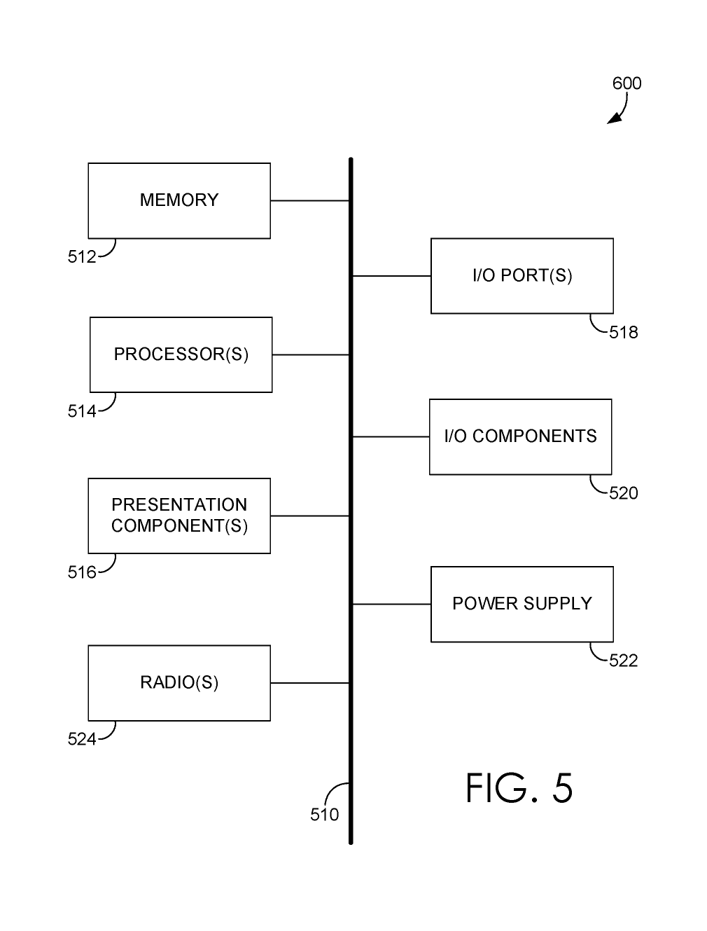

Referring now to FIG. 1, a block diagram is provided that illustrates an identity correlation system 100 for correlation and deduplication of identities, in accordance with an embodiment of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory. The identity correlation system 100 may be implemented via any type of computing device, such as computing device 500 described below with reference to FIG. 5, for example. In various embodiments, the identity correlation system 100 may be implemented via a single device or multiple devices cooperating in a distributed environment.

The identity correlation system 100 generally operates to provide automated correlation and deduplication of identities in an enterprise. As shown in FIG. 1, the identity correlation system 100 includes, among other components not shown, user device 110, requesting system 112, correlation engine 114, ID provider(s) 116a-116c, and ID repository 118. It should be understood that the identity correlation system 100 shown in FIG. 1 is an example of one suitable computing system architecture. Each of the components shown in FIG. 1 may be implemented via any type of computing device, such as computing device 500 described with reference to FIG. 5, for example.

The components may communicate with each other via a network 120, which may include, without limitation, one or more local area networks (LANs) and/or wide area networks (WANs). Such networking environments are commonplace in offices, enterprise-wide computer networks, intranets, and the Internet. It should be understood that any number of user devices, requesting systems, correlation engines, ID repositories, and ID providers may be employed within the identity correlation system 100 within the scope of the present disclosure. Each may comprise a single device or multiple devices cooperating in a distributed environment. For instance, the correlation engine 114 may be provided via multiple devices arranged in a distributed environment that collectively provide the functionality described herein. Additionally, other components not shown may also be included within the network environment.

As shown in FIG. 1, the identity correlation system 100 includes an ID repository 118. While only a single ID repository 118 is shown in FIG. 1, it should be understood that the identity correlation system 100 may employ any number of ID repositories. Each of the identity providers may have a local ID repository that includes local identity attributes that may be utilized by the correlation engine to establish mapped linkages, as described in more detail below. The ID repository 118 may also store the mapped linkages that have been established in order to map a single identity to a user that can be used across the enterprise.

The identity correlation system 100 provides an automated process that initially begins with a requesting system 112 providing an online enrollment form or registration user interface to a user via the user device 110. During the enrollment process, various user attributes are captured and provided to the correlation engine 114 and/or the identity provider(s) 116a-116c. In some embodiments, social security numbers are not utilized as user attributes by the correlation engine. Additionally or alternatively, dates of birth, phone numbers, and/or addresses are not utilized as a user attribute by the correlation engine.

As described below, this enables the identity correlation system 100 to determine if the enrolling user already had an identity in the enterprise organization and reclaim prior account history for the user. For clarity, the enterprise organization may include any subsidiaries, related providers, or any provider that is part of the identity correlation system 100. In some embodiments, the correlation is accomplished in near real time, at the point of user enrollment. In this regard, a user creating an account can be prompted if an existing account is found that has a high probability of belonging to the user. In some embodiments, if an existing account(s) is identified as having a high probability of belonging to the user, the existing account(s) is not directly revealed to the user unless the user can prove the existing account(s) actually belongs to the user. For example, automated business rules can be invoked to ascertain sufficient attribute data from the user to provide a high probability of a match, which can be further based on risk or value of the transaction (as described below).

The requesting system communicates a message with selected identifying attributes (i.e., identity attributes) across a message bus (e.g., the network 120). In response, the ID provider(s) 116a-116c provide a list of potentially matching user accounts. The potentially matching user accounts may be identified by a local correlation engine that compares the identity attributes to local attributes known and stored by the ID provider(s) 116a-116c.

The potentially matching user accounts may then be processed by the correlation engine 114 by analyzing a number of variables about each potentially matching user account. The variables include, in various embodiments, freshness of the data that the potentially matching user account is based on, strength of the potentially matching user account, and/or number of independent attributes corresponding to each potentially matching user account. The correlation engine 114 predicts the likelihood of a match to determine a likely matching user account. The likely matching user account and the new user account can then be correlated through a mapped linkage and recorded in the ID repository, and the history corresponding to the likely matching user account can be properly associated with the new user account.

In some embodiments, additional meta-data may be processed by the correlation engine 114. For example, a strength of validity of an attribute (e.g., a credibility factor/score based on independent confirmation) or a validity of the linkage/relationship to the user may be utilized to identity likely matching user accounts. For instance, if a form asks for information a user does not want to divulge (e.g., address), the user may enter “123 Main St, Nowhere, NV 12345” (which might pass the entry form validation for having the correct format) but would have a low credibility score since it may not exist. Also, because it is self-reported by the user entering the information, it may not have any independent confirmation/corroboration. However, if the user enters an address that corresponds to a notice with a PIN code that has previously been sent to that address by the provider, even though the confirmation of the PIN code does not physically place the user at that address (e.g., it could be an address of a friend or family member), the strength of validity for that address may be higher.

If the potentially matching user account is not determined to be a likely matching user account, the potentially matching user account can be dismissed as not being sufficiently likely that a correlation exists. If the potentially matching user account is not determined to be a likely matching user account, the new user account can be resubmitted through the process to seek additional clarification or details. Alternatively, if the potentially matching user account is not determined to be a likely matching user account, the potentially matching user account is dismissed as not being sufficiently likely that a correlation exists.

In some embodiments, the correlation engine 114 considers the value of a transaction or the risk if an incorrect correlation is created. For example, depending on the type of account the user is creating, actions or transactions initiated with the account may have minimal or low risk (e.g., a movie ticket website) or high risk (e.g., a bank website). As a result, the strength required for assumption of a correct correlation may vary in accordance with that risk.

In some embodiments, the combination of identity attributes used to define the uniqueness of a user is flexible and customizable by each identity provider. Similarly, the ranking of results provided by the correlation engine 114 may also be flexible and customizable by the requesting system 112. For example, the correlation engine 114 may determine that two potentially-matching user accounts have the same number of matching attributes (e.g., account 1 matches last name and social security number while account 2 matches last name and middle initial). The requesting system 112 may value the algorithm employed for account 1 higher than the algorithm employed for account 2 (which may have been previously communicated to the correlation engine 114 during configuration or setup). Accordingly, the correlation engine 114 ranks account 1 higher than account 2.

In some embodiments, the correlation engine 114 processes, in parallel, potentially matching user accounts from a plurality of ID providers 116a-116c for a plurality of identities to provide a comprehensive correlation solution for a number of organizations or agencies.

For example, ID provider 116a may be a state department of motor vehicles (DMV) and store the following typical user attributes: full names (first, middle, last, suffix), home address (validated), date of birth, physical attributes (minimal validation), driver's license number, make, model, color, and vehicle identifier number (VIN). ID provider 116b may be the Department of Children and Family Services (DCFS) and store name, address (validated), dates of birth of multiple members of the family, school district, and an exact dollar amount of any monthly benefit. ID provider 116c may be a county recreation center and store attributes including name, address (not validated), indication of over 18 or not but not date of birth, key tag number (e.g., scan tag for entrance into the center), some information about a method of payment (e.g., last four digits of credit card or bank account), and a listing of classes registered for in the last twelve months.

The correlation of a new request may have some form of name (may correctly correlate or not), address, other family members, and description of physical attributes. In this example, the DMV can validate on name, address, physical attributes, the DCFS can validate on address or family members, and the recreation center can validate on method of payment and classes registered for. If additional correlation is necessary, the DCFS can validate on amount of any monthly benefit.

As can be appreciated, by properly correlating user accounts to a single identity, the identity correlation system 100 provides a better user experience, easier and more accurate historical correlation of accounts, less burden on the organization for password reset, a stronger validity of the user, an overall reduction in the number of orphaned accounts, and a tighter security accountability between accounts and an identity.

Continuing the examples above, using the identity correlation system 100, each of the user accounts may be properly correlated with the correct identity. In the government benefits example, this may enable the user to receive the benefits the user is entitled to receive. Conversely, it may also prevent the government agency from issuing benefits that may have already been issued to the user. In the enterprise organization example, by using the identity correlation system 100, the enterprise organization is able to properly correlate identities across each of the user stores. Ultimately, because the user IDs are correlated, the government agency and/or the enterprise organization is able to reclaim the history and attributes from correlated accounts.

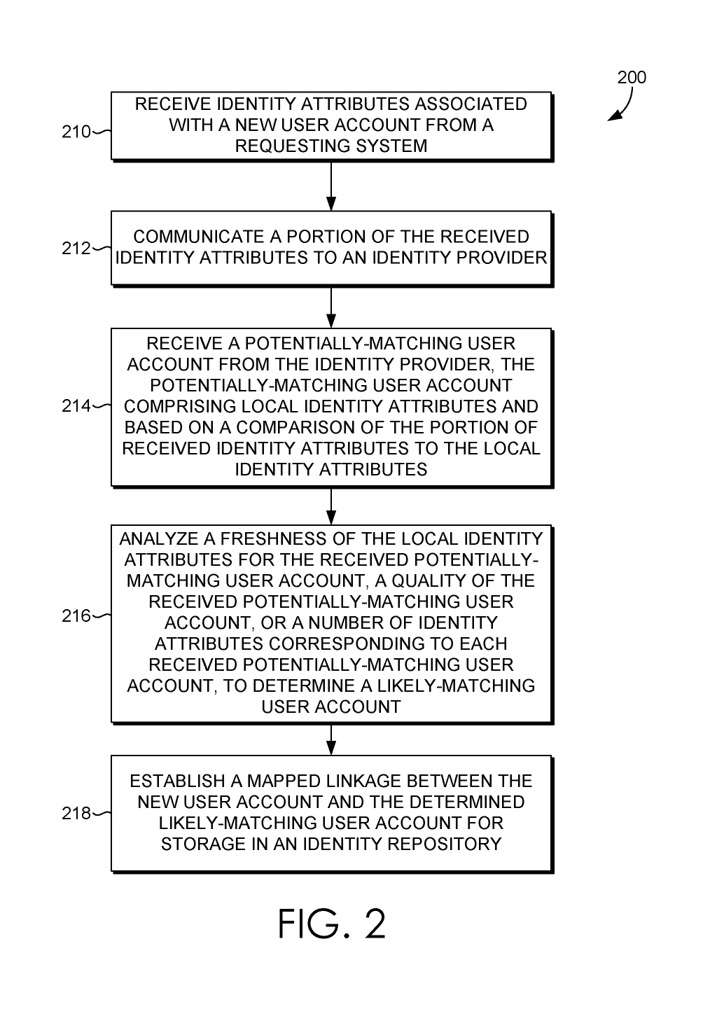

Turning now to FIG. 2, a flow diagram is provided that illustrates a method 200 for facilitating automated correlation and deduplication of identities, in accordance with an embodiment of the present disclosure. For instance, the method 200 may be employed utilizing the identity correlation system 100 of FIG. 1. As shown at step 210, identity attributes associated with a new user account are received from a requesting system.

A portion of the received identity attributes is communicated, at step 212, to an identity provider. In some embodiments, the portion of identity attributes is selected based on predefined business requirements. For example, in the case of unemployment insurance, in addition to personal attributes (name, address, age/date of birth, occupation) there may be specific employer related attributes such as name of employer, length of service, job title, annual/weekly amount of salary, manager's name, employer's tax ID number, etc. If the attributes are sufficiently specific and not publicly available, then the correlation may be entirely automated and the linking accomplished in real-time.

The identity provider may have a local correlation engine that compares the identity attributes received from the requesting system to local identity attributes. The local identity attributes correspond to identity attributes of users known by the identity provider (e.g., users of a service provided by the identity provider). For example, because the user already has an account with the identity provider, the identity provider may have local identity attributes stored in a local ID repository for that user. When the requesting system communicates the identity attributes to the identity provider, the identity provider can compare the identity attributes to local identity attributes stored in the local ID repository.

In some embodiments, each identity provider includes a local correlation engine that provides potentially matching user accounts based at least in part on a comparison of the communicated portion of identity attributes to local identity attributes associated with established user accounts known by the identity provider. In some embodiments, the local correlation engine determines which local identity attributes to provide in association with potentially matching user accounts.

A potentially matching user account is received, at step 214, from the identity provider. As mentioned above, the potentially matching user account includes local identity attributes and is based on a favorable comparison of the portion of received identity attributes to the local identity attributes. In some embodiments, each potentially matching user account is received from the identity provider at a time the new user account is created. In some embodiments, each potentially matching user account is received from the identity provider as a data dump on a scheduled or requested basis. Duplicate identities that have been created in the interim can be de-duplicated using aspects described herein.

To determine whether the potentially matching user account is a likely matching user account, a freshness of the local identity attributes for the received potentially matching user account, a quality of the received potentially matching user account, or a number of identity attributes corresponding to the received potentially matching user account are analyzed, such as by a correlation engine, at step 216.

A mapped linkage is established, at step 218, between the new user account and the determined likely matching user account for storage in an identity repository. This enables the single identity corresponding to the likely matching user account to be associated with the new user account in the identity repository. Accordingly, all history for the likely matching user account can be associated with the new user account.

In some embodiments, a transaction value for the received potentially matching user account can be analyzed. In one example, the transaction value may be based on a risk corresponding to establishing a mistaken mapped linkage between the new user account and the determined likely matching user account. In another example, the transaction value may be based on a type of website or a monetary value associated with the new user account. In this way, the risk of mapping the wrong accounts, or the potential risk to the user or provider, may initially be considered prior to linking any accounts.

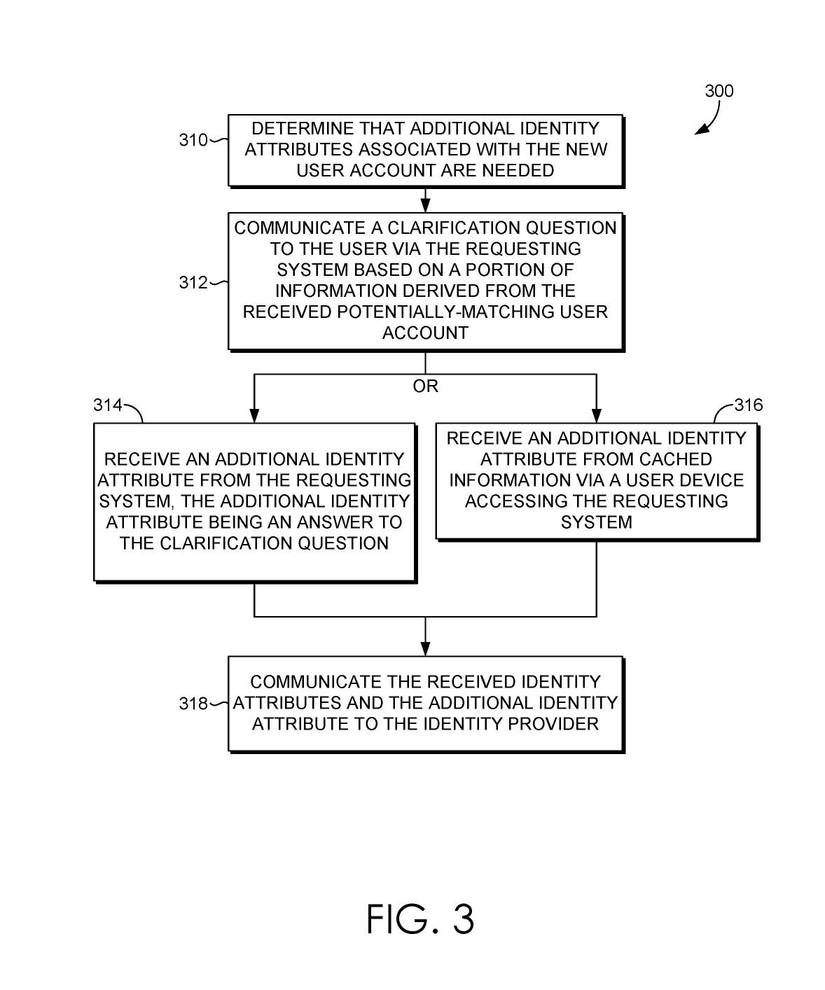

In some embodiments, and referring now to FIG. 3, a flow diagram is provided that illustrates a method 300 for facilitating automated correlation and deduplication of identities using additional identity attributes, in accordance with an embodiment of the present disclosure. For instance, the method 300 may be employed utilizing the identity correlation system 100 of FIG. 1. As shown at step 310, it is determined that an additional identity attribute associated with the new user account is needed. For example, if a potentially matching user account is not determined to be a likely matching user account, the new user account can be resubmitted through the process to seek additional clarification or details. In this case, a clarification question is communicated, at step 312, to the user via the requesting system based on a portion of information derived from the received potentially matching user account.

In some embodiments, an additional identity attribute is received, at step 314, from the requesting system. The additional identity attribute may be an answer to the clarification question. Additionally or alternatively, an additional identity attribute may be received, at step 316, from cached information via a user device accessing the requesting system. The received identity attributes and the additional identity attribute are communicated, at step 318, to the identity provider. In some embodiments, the received identity attributes and the additional identity attribute are communicated via the bus so other identity providers may provide additional matches based on the new information.

In response, the identity provider may provide a potentially matching user account based on a comparison of the portion of the received identity attributes and the additional identity attribute to local identity attributes of the potentially matching user account. The correlation engine may determine a likely matching user account, as described above, and a mapped linkage may be established between the new user account and the determined likely matching user account.

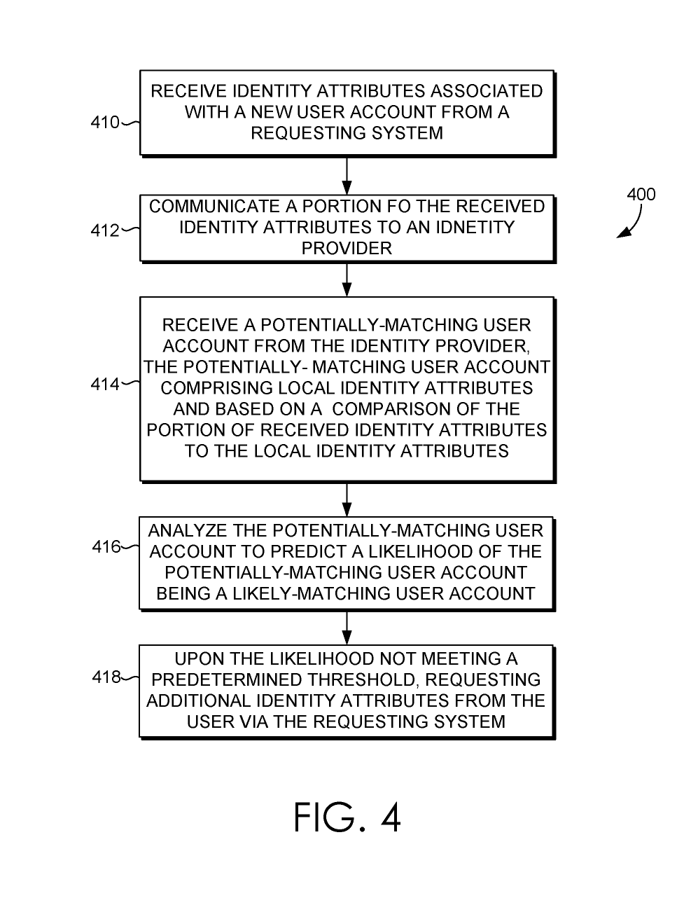

In FIG. 4, a flow diagram is provided that illustrates a method 400 for facilitating automated correlation and deduplication of identities, in accordance with an embodiment of the present disclosure. For instance, the method 400 may be employed utilizing the identity correlation system 100 of FIG. 1. As shown at step 410, identity attributes associated with a new user account are received from a requesting system. A portion of the received identity attributes are communicated, at step 412, to an identity provider. The portion of the received identity attributes that are selected to be communicated may be selected based on business rules of the requesting system.

At step 414, a potentially matching user account is received from the identity provider. As described above, the potentially matching user account includes local identity attributes and is based on a comparison of the portion of received identity attributes to the local identity attributes. In some embodiments, each identity provider includes a local identity correlation engine that compares the communicated portion of identity attributes to the local identity attributes associated with established user accounts known by the identity provider. The potentially matching user account is analyzed, at step 416, to predict a likelihood of the potentially matching user account being a likely matching user account. Upon the likelihood not meeting a predetermined threshold, additional identity attributes are requested, at step 418, from the user via the requesting system.

In some embodiments, the additional identity attributes are requested by communicating a clarification question to the user via the requesting system based on a portion of information derived from the potentially matching user account from the identity provider. In response, an additional identity attribute may be received from the requesting system. In this case, the additional identity attribute may be an answer to the clarification question. Additionally or alternatively, the additional identity attribute may be received from cached information via a user device accessing the requesting system.

Having described embodiments of the present disclosure, an exemplary operating environment in which embodiments of the present disclosure may be implemented is described below in order to provide a general context for various aspects of the present disclosure. Referring to FIG. 5 in particular, an exemplary operating environment for implementing embodiments of the present disclosure is shown and designated generally as computing device 500. Computing device 500 is but one example of a suitable computing environment and is not intended to suggest any limitation as to the scope of use or functionality of the inventive embodiments. Neither should the computing device 500 be interpreted as having any dependency or requirement relating to any one or combination of components illustrated.

The inventive embodiments may be described in the general context of computer code or machine-useable instructions, including computer-executable instructions such as program modules or applications, being executed by a computer or other machine, such as a personal data assistant, smartphone, tablet, or other handheld device. Generally, program modules including routines, programs, objects, components, data structures, etc., refer to code that perform particular tasks or implement particular abstract data types. The inventive embodiments may be practiced in a variety of system configurations, including handheld devices, consumer electronics, general-purpose computers, more specialty computing devices, etc. The inventive embodiments may also be practiced in distributed computing environments where tasks are performed by remote-processing devices that are linked through a communications network.

With reference to FIG. 5, computing device 500 includes a bus 510 that directly or indirectly couples the following devices: memory 512, one or more processors 514, one or more presentation components 516, input/output (I/O) ports 518, input/output (I/O) components 520, and an illustrative power supply 522. Bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 5 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 5 and reference to “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 512 includes computer-storage media in the form of volatile and/or nonvolatile memory. The memory may be removable, non-removable, or a combination thereof. Exemplary hardware devices include solid-state memory, hard drives, optical-disc drives, etc.

Computing device 500 includes one or more processors that read data from various entities, such as memory 512 or I/O components 520. Presentation component(s) 516 present data indications to a user or other device. Exemplary presentation components include a display device, speaker, printing component, vibrating component, etc.

I/O ports 518 allow computing device 500 to be logically coupled to other devices including I/O components 520, some of which may be built in. Illustrative components include a microphone, joystick, game pad, satellite dish, scanner, printer, wireless device, etc. The I/O components 520 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 500. The computing device 500 may be equipped with depth cameras, such as stereoscopic camera systems, infrared camera systems, RGB camera systems, and combinations of these, for gesture detection and recognition. Additionally, the computing device 500 may be equipped with accelerometers or gyroscopes that enable detection of motion. The output of the accelerometers or gyroscopes may be provided to the display of the computing device 500 to render immersive augmented reality or virtual reality.

As can be understood, embodiments of the present disclosure provide for an objective approach for correlating and de-duplicating identities. The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A non-transitory computer storage medium storing computer-useable instructions that, when used by a computing device, cause the computing device to perform operations, the operations comprising:
receiving identity attributes associated with a new user account from a requesting system;
communicating a portion of the received identity attributes to an identity provider;
receiving a potentially matching user account from the identity provider, the potentially matching user account comprising local identity attributes and based on a comparison of the portion of received identity attributes to the local identity attributes;
analyzing a freshness of the local identity attributes for the received potentially matching user account, a quality of the received potentially matching user account, or a number of identity attributes corresponding to the received potentially matching user account, to determine a likely matching user account; and
establishing a mapped linkage between the new user account and the determined likely matching user account for storage in an identity repository.

2. The computer storage medium of claim 1, further comprising analyzing a transaction value for the received potentially matching user account.

3. The computer storage medium of claim 2, wherein the transaction value is based on a risk corresponding to establishing a mistaken mapped linkage between the new user account and the determined likely matching user account.

4. The computer storage medium of claim 2, wherein the transaction value is based on a monetary value associated with the new user account.

5. The computer storage medium of claim 1, further comprising determining that an additional identity attribute associated with the new user account is needed.

6. The computer storage medium of claim 5, further comprising communicating a clarification question to the user via the requesting system based on a portion of information derived from the received potentially matching user account.

7. The computer storage medium of claim 6, further comprising receiving an additional identity attribute from the requesting system, the additional identity attribute being an answer to the clarification question.

8. The computer storage medium of claim 7, further comprising communicating the received identity attributes and the additional identity attribute to the identity provider.

9. The computer storage medium of claim 1, wherein the portion of identity attributes is selected based on predefined business requirements.

10. The computer storage medium of claim 5, further comprising receiving an additional identity attribute from cached information via a user device accessing the requesting system.

11. The computer storage medium of claim 1, wherein each identity provider comprises a local correlation engine that provides potentially matching user accounts based at least in part on a comparison of the communicated portion of identity attributes to local identity attributes associated with established user accounts known by the identity provider.

12. The computer storage medium of claim 11, wherein the local correlation engine determines which local identity attributes to provide in association with potentially matching user accounts.

13. The computer storage medium of claim 1, wherein each potentially matching user account is received from the identity providers at a time the new user account is created.

14. The computer storage medium of claim 1, wherein each potentially matching user account is received from the identity providers as a data dump on a scheduled or requested basis.

15. A method comprising:
receiving identity attributes associated with a new user account from a requesting system;
communicating a portion of the received identity attributes to an identity provider;
receiving a potentially matching user account from the identity provider, the potentially matching user account comprising local identity attributes and based on a comparison of the portion of received identity attributes to the local identity attributes;
analyzing the potentially matching user account to predict a likelihood of the potentially matching user account being a likely matching user account; and
upon the likelihood not meeting a predetermined threshold, requesting additional identity attributes from the user via the requesting system.

16. The method of claim 15, wherein the requesting comprises communicating a clarification question to the user via the requesting system based on a portion of information derived from the potentially matching user account from the identity provider.

17. The method of claim 16, further comprising receiving an additional identity attribute from the requesting system, wherein the additional identity attribute is an answer to the clarification question.

18. The method of claim 15, further comprising receiving the additional identity attribute from cached information via a user device accessing the requesting system.

19. The method of claim 15, wherein each identity provider comprises a local identity correlation engine that compares the communicated portion of identity attributes to the local identity attributes associated with established user accounts known by the identity provider.

20. A system comprising:
a processor; and
a non-transitory computer storage medium storing computer-useable instructions that, when used by the processor, cause the processor to:
determine that identity attributes associated with a new user account received from a requesting system correspond to a potentially matching user account, the potentially matching user account received from an identity provider and based on a comparison of the identity attributes to local identity attributes associated with an established user account known by the identity provider;
analyze the potentially matching user account to predict a likelihood of the potentially matching user account being a likely matching user account;
upon the likelihood meeting a predetermined threshold, establish a mapped linkage between the new user account and the likely matching user account for storage in an identity repository; and
upon the likelihood not meeting a predetermined threshold, request additional identity attributes from the user via the requesting system.
